(19) United States
(12) Patent Application Publication
(10) Pub. No.: US 2007/0100823 A1
(43) Pub. Date: May 3, 2007

(54) Techniques for manipulating unstructured data using synonyms and alternate spellings prior to recasting as structured data

(75) Inventor: William H. Inmon, Castle Rock, CO (US)

Correspondence Address: Chad R. Walsh;Fountainhead Law Group P.C., Suite 509, 900 Lafayette St., Santa Clara, CA, 95050, US

(73) Assignee: Inmon Data Systems, Inc., Castle Rock, CO (US)

(21) Appl. No.: 11/584,882

(22) Filed: Oct. 23, 2006

Related U.S. Application Data
(60) Provisional application No. 60/729,126, filed on Oct. 21, 2005.

(51) Int. Cl. G06F 17/30

(52) U.S. Cl. 707/6

(57) ABSTRACT

Unstructured data is manipulated so that the unstructured data is placed in a form that is more compatible with a structured data environment. The manipulation includes editing the unstructured data in preparation for integration into a structured data environment. Specifically, one or more editing programs edit unstructured text using a synonym list and/or an alternate spellings list. Once unstructured text is ready for processing, the unstructured text is examined a word and/or a phrase at a time to determine if there is a match with words or phrases in the synonym list or the alternate spelling list. If a match is found, the synonym or alternate spelling is either replaced in the unstructured document or added to the unstructured document. The unstructured document is then ready for further editing and manipulation in preparation for entry into the structured environment.

### CROSS-REFERENCE TO RELATED APPLICATIONS

This invention claims the benefit of priority from U.S. Provisional Application No. 60/729,126, filed Oct. 21, 2005, entitled “Techniques For Manipulating Unstructured Data Using Synonyms And Alternate Spellings Prior To Recasting As Structured Data.”

### BACKGROUND OF THE INVENTION

1. Field of the Invention

The present invention relates to techniques for structuring unstructured data, and more particularly, to techniques for locating and replacing synonyms and words having alternate spellings in unstructured data.

2. Description of the Related Art

As the name suggests, unstructured data is data that lacks structure. Unstructured data can come in the form of email, transcripted telephone conversations, spreadsheets, documents, letters, and other forms. There are no rules for organizing data in emails. There are no rules for organizing data in a telephone conversation. Instead, unstructured data is free-form. Individuals and corporations have used unstructured data for a long time.

Juxtaposed to unstructured data is structured data. Structured data is data that contains a structure. For example, structured data can be formatted into records, tables, and attributes. Typically, computerized operating systems and data base management systems operate on structured data. Structured records are usually placed in a file. Once in a file or a data base, the records can be accessed and used for a variety of purposes. Structured data is typically organized in a defined format. The same type of data appears and reappears in the different records. Structured data is ideal for computerized transaction processing. For example, bank transactions, airline reservations, insurance claims, manufacturing assembly work and so forth are executed using structured data.

For years, organizations have used unstructured data and structured data. The unstructured and structured data environments have grown up beside each other, but there has been very little interaction between these two environments. The two environments often operate in complete isolation from each other. Yet, merging and/or intertwining structured data environments and unstructured data environments can provide great benefits to many businesses.

However, there are many problems associated with merging structured data and unstructured data. One of the major problems relates to the internal organization of the data itself. Strict control is placed over the organization of structured data. On the other hand, there is no control placed on the organization of unstructured data. As a result, when the two types of data are merged together, there is a colossal mismatch. Simply combining structured data with unstructured data does not produce meaningful information. Therefore, it would be highly desirable to provide techniques for combining structured data with unstructured data to generate useful information.

### SUMMARY

The present invention provides techniques for manipulating unstructured data to place it in a form that makes it more suitable to be combined with structured data. The manipulation includes editing the unstructured data in preparation for integration into a structured data environment. Specifically, one or more editing programs edit unstructured data using a synonym list and/or an alternate spellings list. Embodiments of the present invention include systems and methods for gathering, storing, and/or displaying of unstructured data editing for synonym resolution and alternate spelling resolution.

Once unstructured text is ready for processing, the unstructured text is examined a word and/or a phrase at a time to determine if there is a match with words or phrases in the synonym list or the alternate spelling list. If a match is found, the synonym or alternate spelling is either replaced in the unstructured document or added to the unstructured document. The unstructured document is then ready for further editing and manipulation in preparation for entry into a structured environment.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 illustrates the basic components of a system for editing unstructured data using a synonym list and their general relationship to each other, according to an embodiment of the present invention.

FIG. 2 is a flow chart that illustrates a process for editing unstructured data using a synonym list, according to an embodiment of the present invention.

FIG. 3 illustrates an example of results generated by a synonym replacement process, according to an embodiment of the present invention.

FIG. 4 illustrates an example of results generated by a synonym addition process, according to an embodiment of the present invention.

FIG. 5 illustrates the basic components of a system for editing unstructured data using an alternate spelling list and their general relationship to each other, according to an embodiment of the present invention.

FIG. 6 is a flow chart that illustrates a process for editing unstructured data using an alternate spelling list, according to an embodiment of the present invention.

FIG. 7 illustrates an example of results generated by an alternate spelling replacement process, according to an embodiment of the present invention.

FIG. 8 illustrates an example of results generated by an alternate spelling addition process, according to an embodiment of the present invention.

FIG. 9 illustrates the components of a system for processing unstructured data using a synonym list and an alternate spelling list, according to an embodiment of the present invention.

### DETAILED DESCRIPTION OF THE INVENTION

The present invention includes systems and methods for processing synonyms and alternate spellings in preparation for further processing and entry into a structured environment. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

Combining structured data environments and unstructured data environments can provide great benefits. Many different business opportunities emerge when the two environments are integrated. For example, in customer relationship management (CRM), an organization attempts to form a close relationship with its customers and its prospects. The organization collects demographic data about the customer. But when communications such as emails, telephone conversations, other documents are added to a mass of customer information, the ability to get to know the customers is exponentially enhanced. Emails, telephone conversations, and documents are all forms of unstructured information. Therefore, adding unstructured data to the structured CRM environment enables organizations that want to engage in CRM to use entirely new and powerful types of processing.

One of the many problems associated with preparing unstructured data for merger with structured data is that of resolving synonyms and alternate spellings of words. A synonym is a word that has the same meaning as another word. As a simple example of a synonym, consider the word “walk”. A synonym for the word “walk” is the word “stroll”.

Also, there are many alternate spellings of words. Consider the name “Osama Bin Laden”. “Osama Bin Laden” is often spelled “Usama Ben Laden”. Both alternate spellings refer to the same person. When preparing unstructured data to integrate it with or enter it into a structured environment, it is often desirable to reconcile synonyms as well as words and phrases that are spelled differently.

According to the present invention, synonyms and alternate spellings are replaced in unstructured data prior to integrating the unstructured data into a structured data environment. The techniques of the present invention allow unstructured data to be collected together and organized within a structured environment in ways that are not possible if synonyms and alternate spellings are not identified. If synonyms and alternate spellings are not identified, similar types of data may be grouped separately in the structured environment, limiting the utility of the data organization provided by the structured environment. According to one embodiment, synonym replacement and alternate spelling replacement can be done at the same time, because the processes of reconciling synonyms and alternate spellings are similar.

Two basic techniques that are used to reconcile synonyms and alternate spellings are now described. The first technique involves replacing one word or phrase with another. The other technique involves adding a word or phrase without replacing any of the original words. Both of these techniques can be used to manage multiple synonyms as well as multiple alternate spellings of words and phrases.

Once the text in the unstructured environment is edited for synonyms and alternate spellings, the text is then ready for further processing in order to enter a structured environment. Further editing can be done by the same program that performed the synonym and alternate spelling editing. Alternatively, another editor can be used to perform additional editing to the unstructured data.

A synonym list includes pairs of words and/or phrases. An alternate spelling list also includes pairs of words and/or phrases. If desired, the synonym list and the alternate spelling list can be combined into a single list, because the processing for synonyms and alternate spellings can be identical, according to certain embodiments of the present invention.

In the synonym list and in the alternate spelling list, there may be multiple occurrences of the same word or phrase in different pairings. For example, in the synonym list, there may be pairs such as “walk—stroll”, “walk—amble”, “walk—pathway”. In the alternate spellings list, there may be the pairs “Osama Bin Laden—Usama Bin Laden”, “Osama Bin Laden—Osama Ben Laden”, “Osama Bin Laden—Usama Ben Laden”, and so forth.

The techniques of the present invention can be used to edit text by replacing certain words and phrases using a synonym list and/or an alternate spelling list. By making the editing changes suggested in a synonym list and/or an alternate spelling list, the unstructured data becomes much more pliant and much more usable as it is readied for entry and integration into a structured environment.

Embodiments of the present invention include unstructured bridging software that may be used to capture, organize, store, and display unstructured data and prepare that unstructured data for the purpose of integrating it with and sending it to a structured environment. An editor may be used to perform these functions, for example. In this description, the editor is referred to as the “foundation.” In particular, the foundation software can access both unstructured data as well as synonym and alternate spelling lists. When the synonym and alternate spelling lists are accessed, a cross checking is made to determine if a word or phrase in an unstructured document also appears in the synonym list or in the alternate spelling list. If the foundation software finds a match, the synonym or the alternate spelling is either replaced in the unstructured document or added to the unstructured document, depending on the instructions provided by the operator.

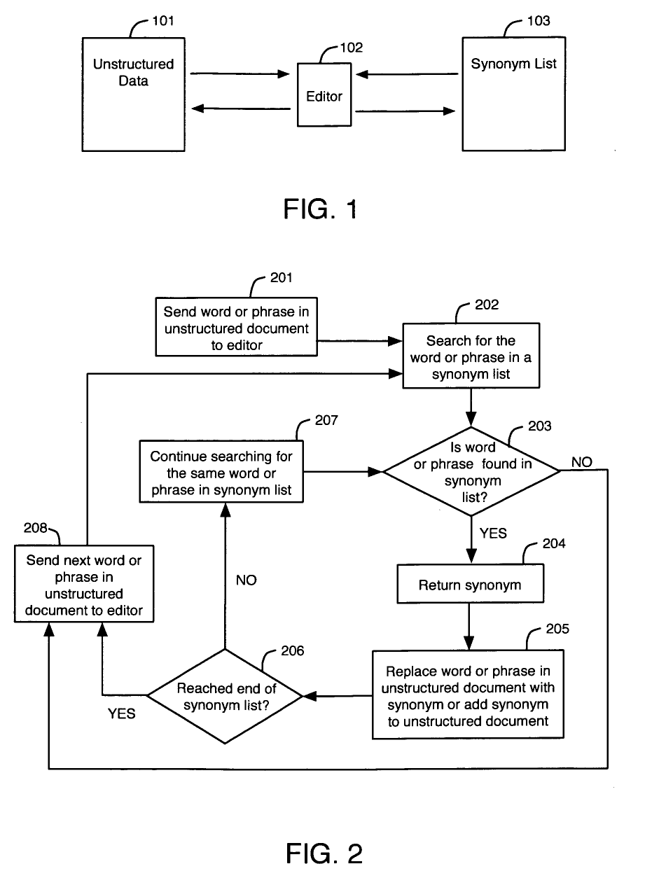

FIG. 1 illustrates the flow of information using foundation software (i.e., editor 102). Editor 102 reads the unstructured data 101—word by word. Each word and/or phrase of unstructured data 101 is compared to the words and phrases in a synonym list 103. If a match is found, the unstructured word or phrase is either replaced by a corresponding word or phrase found in synonym list 103 or the corresponding word or phrase is added to unstructured data 101. Editor 102 then checks if there is another synonym for the same word or phrase. If the editor 102 locates another match in synonym list 103, then the process is repeated until the word or phrase being sought no longer matches any more words or phrases in synonym list 103.

FIG. 2 is a flow chart that illustrates a process for editing unstructured data using a synonym list, according to an embodiment of the present invention. At step 201, a first word or phrase in an unstructured document is sent to editor 102 of the present invention. At step 202, editor 102 searches for the word or phrase in a synonym list. If the editor finds the word or phrase in the synonym list at decisional step 203, a synonym is returned at step 204. The synonym can be one word or multiple words.

At step 205, the word or phrase in the unstructured document is replaced with the synonym. Alternatively, the synonym is added to the unstructured document at step 205 without replacing the original word or phrase. If the editor has not reached the end of the synonym list at step 206, the editor continues searching for the same word or phrase in the synonym list at step 207 to determine if that word or phrase matches any other words or phrases in the synonym list. The process then returns to decisional step 203.

If the editor does not find the current word or phrase in the synonym list at decisional step 203, the next word or phrase in the unstructured document is sent to the editor at step 208. Also, if the editor reaches the end of the synonym list at step 206, the next word or phrase in the unstructured document is sent to the document editor at step 208. Editor 102 then searches for the new word or phrase in the unstructured document at step 202. The process repeats until all of the words and phrases in the unstructured document have been analyzed.

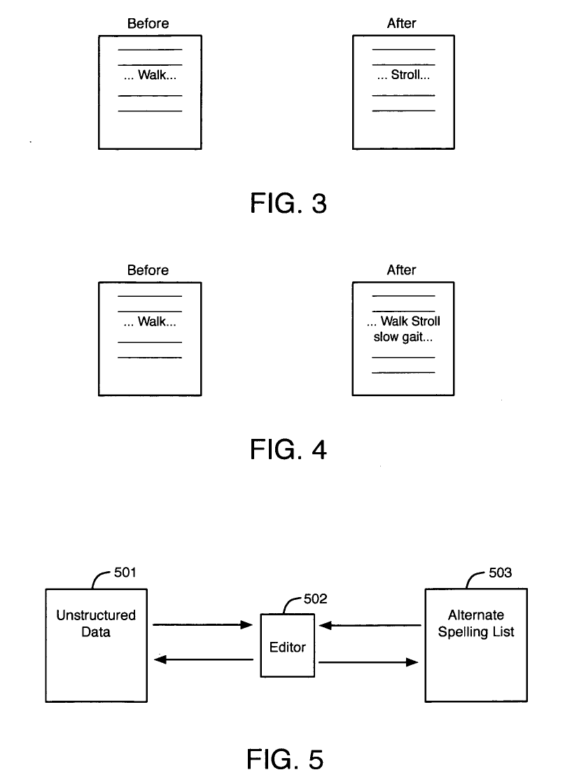

FIG. 3 illustrates an example of results generated by a synonym replacement process, according to an embodiment of the present invention. In this example, the word “walk” has been replaced by the word “stroll” in the unstructured document. FIG. 4 illustrates an example of results generated by a synonym addition process, according to an embodiment of the present invention. In this example, the words “stroll” and slow gait” have been added to the unstructured document.

FIG. 5 illustrates the basic components of a system for editing unstructured data using an alternate spelling list and their general relationship to each other, according to an embodiment of the present invention. Editor 502 reads the unstructured data 501—word by word. Each word and/or phrase of unstructured data 501 is compared to the words and phrases in an alternate spelling list 503. If a match is found, the unstructured word or phrase is either replaced by a corresponding word or phrase found in alternate spelling list 503 or the corresponding word or phrase is added to unstructured data 501. Editor 502 then checks if there is another alternate spelling for the same word or phrase. If the editor 502 locates another match in alternate spelling list 503, is the process is repeated until the word or phrase being sought no longer matches any more words or phrases in alternate spelling list 503.

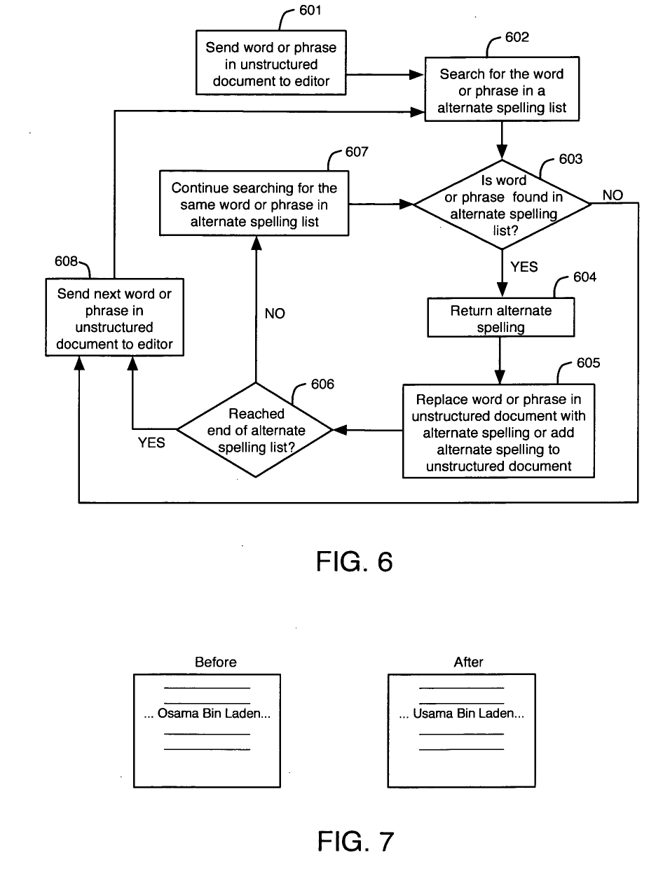

FIG. 6 is a flow chart that illustrates a process for editing unstructured data using an alternate spelling list, according to an embodiment of the present invention. At step 601, a first word or phrase in an unstructured document is sent to an editor of the present invention. At step 602, the editor searches for the word or phrase in an alternate spelling list. If the editor finds the word or phrase in the alternate spelling list at decisional step 603, an alternate spelling is returned at step 604. The alternate spelling can include one word or multiple words.

At step 605, the word or phrase in the unstructured document is replaced with the alternate spelling. Alternatively, the alternate spelling is added to the unstructured document at step 605 without replacing the original word or phrase. If the editor has not reached the end of the alternate spelling list at step 606, the editor continues searching for the same word or phrase in the alternate spelling list at step 607 to determine if that word or phrase matches any other words or phrases in the alternate spelling list. The process then returns to decisional step 603.

If the editor does not find the current word or phrase in the alternate spelling list at decisional step 603, the next word or phrase in the unstructured document is sent to the editor at step 608. Also, if the editor reaches the end of the alternate spelling list at step 606, the next word or phrase in the unstructured document is sent to the editor at step 608. The editor then searches for the new word or phrase in the unstructured document at step 602. The process repeats until all of the words and phrases in the unstructured document have been analyzed.

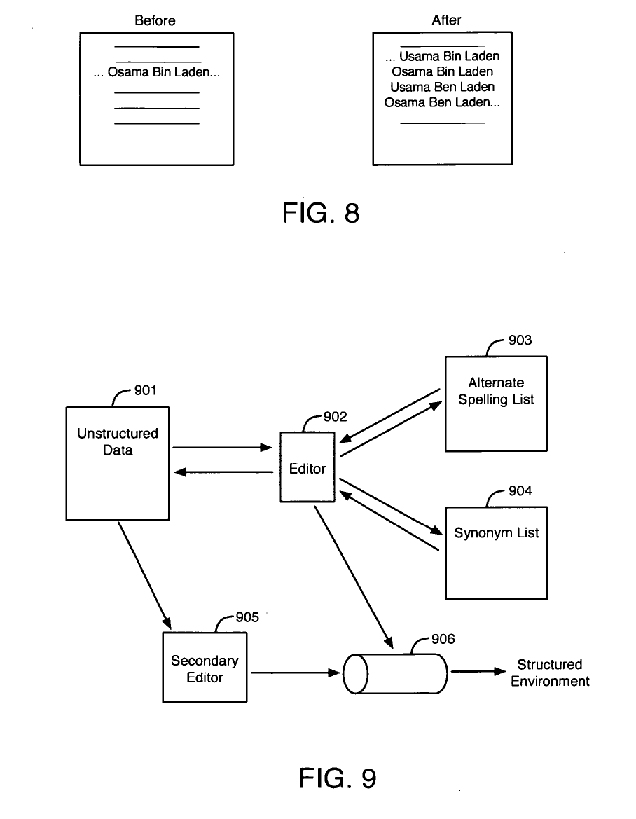

FIG. 7 illustrates an example of results generated by an alternate spelling replacement process, according to an embodiment of the present invention. In the example of FIG. 7, the name “Osama Bin Laden” has been replaced by the name “Usama Bin Laden” in the unstructured document. FIG. 8 illustrates an example of results generated by an alternate spelling addition process, according to an embodiment of the present invention. In the example of FIG. 8, three alternate spellings for “Osama Bin Laden” have been added to an unstructured document, while retaining the original spelling in the unstructured document.

FIG. 9 illustrates the components of a system for processing unstructured data using a synonym list and an alternate spelling list, according to another embodiment of the present invention. Editor 902 can edit unstructured data 901 using alternate spelling list 903 and synonym list 904, as described above. Editor 902 can then do other editing for the purpose of sending data to a structured environment. In addition, after synonym and alternate spelling editing is done, unstructured data 901 can be sent to secondary editor 905 for further processing before being sent to the structured environment. The unstructured data edited by editor 902 and the unstructured data edited by secondary editor 905 can be combined into one document by process 906, before being sent to the structured environment.

The foregoing description of the exemplary embodiments of the invention has been presented for the purposes of illustration and description. It is not intended to be exhaustive or to limit the invention to the precise form disclosed. A latitude of modification, various changes, and substitutions are intended in the present invention. In some instances, features of the invention can be employed without a corresponding use of other features as set forth. Many modifications and variations are possible in light of the above teachings, without departing from the scope of the invention. It is intended that the scope of the invention be limited not with this detailed description, but rather by the claims appended hereto.

What is claimed is:

1. A method of processing data comprising:
accessing unstructured data, wherein the unstructured data comprises a plurality of words;
accessing a list of words or phrases comprising synonyms or alternate spellings; and
cross-checking the unstructured data against the list to determine if a word or phrase in the unstructured data appears in the list.

2. The method of claim 1 further comprising replacing a word or phrase from the unstructured data with a word or phrase from the list if the word or phrase from the unstructured data appears in the list.

3. The method of claim 1 further comprising outputting a plurality of words or phrases from the list that match a single word or phrase from the unstructured data.

4. The method of claim 1 further comprising adding a word or phrase from the list to the unstructured data if a word or phrase from the unstructured data matches a word or phrase from the list.

5. The method of claim 1 wherein the unstructured data comprises one or more emails.

6. The method of claim 1 wherein the unstructured data comprises one or more documents.

7. The method of claim 1 wherein the unstructured data is generated from a telephone conversation.

8. The method of claim 1 wherein the list comprises a plurality of first words or phrases having associated second words or phrases that are synonyms of the first words or phrases.

9. The method of claim 1 wherein the list comprises a plurality of first words or phrases having associated second words or phrases that are alternate spellings of the first words or phrases.

10. A method of processing data comprising:
reading unstructured data, wherein the unstructured data comprises a plurality of words or phrases;
accessing a list comprising a plurality of first words or phrases, wherein each of the first words or phrases has an associated one or more second words or phrases;
comparing the words or phrases from the unstructured data against the words or phrases in the list; and
modifying one or more words or phrases in the unstructured data with a word or phrase from the list if a match is found.

11. The method of claim 10 wherein the list comprises a plurality of first words or phrases having associated second words or phrases that are synonyms of the first words or phrases.

12. The method of claim 10 wherein the list comprises a plurality of first words or phrases having associated second words or phrases that are alternate spellings of the first words or phrases.

13. The method of claim 10 further comprising:
receiving a word or phrase from the unstructured data;
searching for the received word or phrase in the list; and
returning one or more words or phrases from the list that match the word or phrase from the unstructured data.

14. The method of claim 13 wherein the word or phrase in the unstructured data is replaced with at least one of the matching words or phrases from the list.

15. The method of claim 13 wherein the one or more matching words or phrases from the list are added to the unstructured data.

16. The method of claim 10 wherein the unstructured data comprises one or more documents.

17. The method of claim 10 wherein the unstructured data comprises one or more emails.

18. A computer-readable medium containing instructions for controlling a computer system to perform a method of processing user inputs comprising:
reading unstructured data, wherein the unstructured data comprises a plurality of words or phrases;
accessing a list comprising a plurality of first words or phrases, wherein each of the first words or phrases has an associated one or more second words or phrases;
comparing the words or phrases from the unstructured data against the words or phrases in the list; and
modifying one or more words or phrases in the unstructured data with a word or phrase from the list if a match is found.

19. The method of claim 18 wherein the list comprises a plurality of first words or phrases having associated second words or phrases that are synonyms of the first words or phrases.

20. The method of claim 18 wherein the list comprises a plurality of first words or phrases having associated second words or phrases that are alternate spellings of the first words or phrases.

21. The method of claim 18 further comprising:
receiving a word or phrase from the unstructured data;
searching for the received word or phrase in the list; and
returning one or more words or phrases from the list that match the word or phrase from the unstructured data.

22. The method of claim 21 wherein the word or phrase in the unstructured data is replaced with at least one of the matching words or phrases from the list.

23. The method of claim 21 wherein the one or more matching words or phrases from the list are added to the unstructured data.

24. The method of claim 18 wherein the unstructured data comprises one or more documents.

25. The method of claim 18 wherein the unstructured data comprises one or more emails.
